(19) United States
(12) Patent Application Publication
(10) Pub. No.: US 2023/0289684 A1
(43) Pub. Date: Sep. 14, 2023

(54) SYSTEMS AND METHODS FOR OPTIMALLY SCHEDULING RESOURCES FOR TRIPS

(71) Applicant: THE BOEING COMPANY, Arlington, VA (US)

(72) Inventors: Carl Fredrik Altenstedt, Mölndal (SE); Magnus Björk, Mölnlycke (SE)

(73) Assignee: THE BOEING COMPANY, Arlington, VA (US)

(21) Appl. No.: 18/313,532

(22) Filed: May 8, 2023

Related U.S. Application Data
(63) Continuation-in-part of application No. 18/298,511, filed on Apr. 11, 2023.
Application No. 18/298,511 is a continuation-in-part of application No. 17/683,458, filed on Mar. 1, 2022.

(51) Int. Cl. G06Q 10/0631

(52) U.S. Cl. CPC G06Q 10/06314; G06Q 10/06311

(57) ABSTRACT

A system and a method include one or more control units including one or more processors configured to: receive a compiled ruleset including rules, receive a plan for a trip for one or more vehicles, determine if the rules are applicable to the plan, and discard each of the plurality of rules that is not applicable to the plan.

### CROSS-REFERENCE TO RELATED APPLICATION

This application is a continuation-in-part of U.S. Pat. Application No. 18/298,511, filed Apr. 11, 2023, entitled “Systems and Methods for Determining Crew Rosters for Trips,” which, in turn, is a continuation-in-part of U.S. Pat. Application No. 17/683,458, filed Mar. 1, 2022, entitled “Systems and Methods for Scheduling Resources,” each of which is hereby incorporated by reference in its entirety.

### FIELD OF THE DISCLOSURE

Examples of the present disclosure generally relate to systems and methods for scheduling resources, such as personnel, aircraft, and the like for services, such as flights of aircraft between various airports, and more particularly to systems and methods for automatically and optimally scheduling resources and determining crew rosters for trips, such as flights of the aircraft between the airports.

### BACKGROUND OF THE DISCLOSURE

Aircraft are used to transport passengers and cargo between various locations. Numerous aircraft depart from and arrive at a typical airport every day.

Airline operators schedule various resources for flights over a period of time. For example, flight crews including pilots and flight attendants, aircraft, and the like are scheduled for numerous trips, which can include multiple flights. As an example, a trip from an airport in St. Louis, Missouri to Dublin, Ireland may include a first flight from St. Louis, Missouri to Chicago, Illinois, a second flight from Chicago, Illinois to New York, New York, and a third flight from New York, New York to Dublin, Ireland. The trip including all of the different flights may span multiple days.

Various rules set limits for the scheduling of resources and rostering. As an example, pilots are limited to flying a certain number of hours in a day, a certain amount of block time (that is, the time when a block is removed from a wheel of an aircraft at a gate of an airport until a time that a block is put back on the wheel at another gate of another airport), and the like. As another example, certain maintenance procedures for an aircraft are required after a certain number of flight hours. Various scheduling rules are set by various airline operators, regulatory agencies such as the Federal Aviation Administration (FAA), labor unions, and the like. As can be appreciated, the process of scheduling hundreds of thousands of resources for different entities (including employees, vehicles, maintenance, and the like) according to hundreds if not thousands of different scheduling rules for such entities can be labor and time intensive. Indeed, such scheduling may not be able to be adequately performed by human beings, as such could take weeks if not months.

Accordingly, computers can be used to facilitate scheduling of resources. Rule and Value Evaluation (RAVE) is a proprietary business rules engine. In particular, RAVE is a domain specific functional computer language that is used to express rules for scheduling. However, RAVE typically provides a narrow interface that checks hundreds of millions of possible scheduling options. In short, known scheduling methods generate millions of scheduling permutations that are checked against various scheduling rules using RAVE. Many of the permutations are rejected based on the rules. Such a trial and error method leads to thousands, if not millions, of rejected scheduling options, which consumes computing power and time. Indeed, a typical RAVE checking method can take days to perform, thereby consuming vast amounts of computing power. As such, a planning process may need to be started earlier than desired, which can lead to less planning flexibility, and potentially information that is out of date.

Airline crew planning is typically split into two phases, crew pairing and crew rostering. In crew pairing, a set of anonymous trips are created, with a series of flights starting and ending at a specific crew base. In crew rostering, created trips are assigned to individual crew members. As each trip starts at a crew base, availability of crew members at different bases must be accounted when creating trips in crew pairing. For bases containing numerous crew, it can be enough to put daily limits on the amount of trips flown from that base.

Currently, airline planners are often forced into a manual or iterative process to deal with certain crews. For example, while a particular trip (which can include multiple flights spanning one or more days) may be determined, a crew for such trip may not be available for such trip. A particular airline may have only a certain number of crew members that are available for such trip. As another example, the airline may have only a certain number of pilots trained and certified to fly a particular type of aircraft that is available for one or more flights of the trip. As another example, in certain countries, only a certain number of crew members may be fluent in associated languages. In such scenarios, the trip as initially scheduled may not be able to be properly staffed. Therefore, an individual typically needs to review any resulting conflict, and manually determine one of more alternatives to ensure that crew members are assigned to the different flights. As can be appreciated, such a process is complex, labor intensive, and time-consuming.

### SUMMARY OF THE DISCLOSURE

A need exists for an effective and efficient system and a method for improving rules analysis, such as for scheduling resources, crew rostering, and the like.

With that need in mind, certain examples of the present disclosure provide a system including one or more control units including one or more processors. The one or more controls units is configured to: receive a compiled ruleset including rules, receive a plan for a trip for one or more vehicles, determine if the rules are applicable to the plan, and discard each of the plurality of rules that is not applicable to the plan.

In at least one example, the one or more control units is configured to determine if the rules are applicable to the plan and discard each of the plurality of rules not applicable to the plan during runtime.

In at least one example, the plan includes one or both of resources or crew rosters for the trip. As a further example, the one or more control units is further configured to schedule resources after discarding the rules that are not applicable to the plan. As another example, the one or more control units is further configured to determine one or more rosters of crew members for the trip after discarding the rules that are not applicable to the plan.

In at least one example, the one or more vehicles includes one or more aircraft, and the trip includes a plurality of flights between different airports.

In at least one example, the rules include one or both of scheduling rules or rostering rules.

Certain examples of the present disclosure provide a method including receiving, by one or more control units including one or more processors, a compiled ruleset including rules; receiving, by the one or more control units, a plan for a trip for one or more vehicles; determining, by the one or more control units, if the rules are applicable to the plan; and discarding, by the one or more control units, each of the plurality of rules that is not applicable to the plan.

Certain examples of the present disclosure provide a non-transitory computer-readable storage medium comprising executable instructions that, in response to execution, cause one or more control units comprising a processor, to perform operations including receiving a compiled ruleset including rules; receiving a plan for a trip for one or more vehicles; determining if the rules are applicable to the plan; and discarding each of the plurality of rules that is not applicable to the plan.

### BRIEF DESCRIPTION OF THE DRAWINGS

FIG. 1 illustrates a simplified chart of availability of two crew members during a week, according to an example of the present disclosure.

FIG. 2 illustrates a schematic block diagram of a system for scheduling resources, according to an example of the present disclosure.

FIG. 3 illustrates a flow chart of a method, according to an example of the present disclosure.

FIG. 4 illustrates a chart of execution time in relation to cost for a system for scheduling resources, according to an example of the present disclosure.

FIG. 5 illustrates a chart of execution time in relation to cost for a system for scheduling resources, according to an example of the present disclosure.

FIG. 6 illustrates a perspective front view of an aircraft, according to an example of the present disclosure.

FIG. 7 illustrates a flow chart of a method, according to an example of the present disclosure.

FIG. 8 illustrates a flow chart of a method, according to an example of the present disclosure.

FIG. 9 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

In at least one example, systems and methods are configured to generate scheduling options for resources of a service. The resources can be individuals, such as members of a flight crew (for example, pilots). The resources can be scheduled. For example, a specific individual can be scheduled. A resource constraint relates to the resource. For example, a resource constraint for a pilot can be block time in a predetermined time period (such as a month), number of flights flown in a predetermined time period, and the like.

Examples of the present disclosure provide systems and methods that are configured to ensure that trips generated in crew pairing are efficient and assignable to rosters. The systems and methods are configured to automatically account for information about the crew rosters that the trips are to be assigned, as well as rostering rules and costs. The systems and methods provide efficient and effective crew planning for trips.

In at least one example, the systems and methods include one or more control units that are configured to statically analyze data in order to improve efficiency and optimize operations. The systems and methods are configured to analyze rules, such as for scheduling resources, rostering crews, and/or the like.

Business requirements for each airline, such as rules and cost functions, are expressed in Rule and Value Evaluation (RAVE), which is a proprietary business rules engine. One or more control units, such as an optimization control unit, are configured to interact with compiled RAVE program using concrete values and schedules. The RAVE system can report whether a given plan (for example, a trip, roster, and/or the like) is legal, and its associated cost. In at least one example, one or more control units are configured to perform static analysis of RAVE code, given data from a current plan (such as a plan that schedules resources, rosters crews, and/or the like). The one or more control units provide specific information about a planning problem, thereby specializing runs for current conditions, and gaining significant performance improvements.

Within software verification, there are existing static analysis techniques such as symbolic execution, or symbolic simulation, where programs are interpreted abstractly, using symbolic variables rather than concrete values for inputs and arguments, or partial evaluation, where abstract representations of programs are simplified using runtime information. Typically, analysis of RAVE code is performed without knowledge of values or settings related to a specific planning problem instance. Such a process can be complex, and consume considerable time and computing power. Examples of the present disclosure provide systems and methods that substantially reduce computational complexity, time, and power consumption.

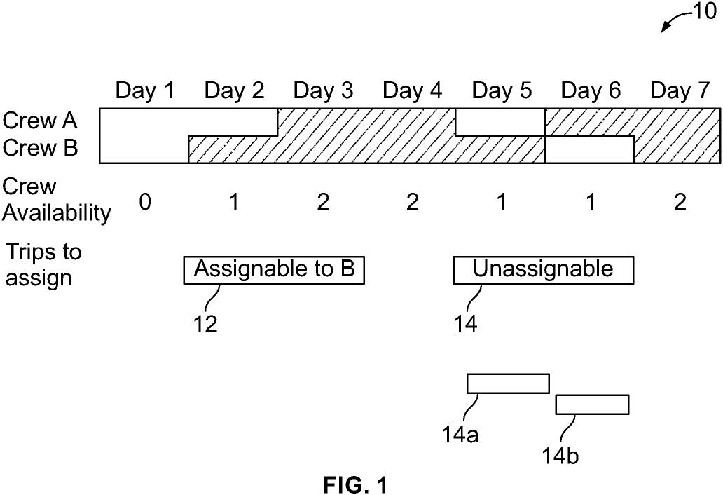

FIG. 1 illustrates a simplified chart 10 of availability of two crew members during a week, according to an example of the present disclosure. For the sake of clarity and simplicity, the chart 10 shows only two crew members - crew member A and crew member B. The chart 10 shows availability for an entire crew, such as a crew having crew member A and crew member B. There may be enough crew members on an aggregate level. However, sometimes, generated trips do not fit with respect to crew availability. The crew members can be vehicle operators, such as pilots, attendants, such as flight attendants, and/or the like. It is to be understood that a crew can include many more crew members than just two. For example, a crew can include ten, twenty, thirty, forty, fifty, or more crew members. Additionally, the time period for the chart can be shorter or longer than a week. As an example, the time period can be a month, year, or longer.

Initially, trips are generated, such as by a scheduling control unit (for example, the scheduling control unit 102 shown in FIG. 1), which can be or otherwise include a trip generator. The trips include a departure destination, such as a first airport, and an arrival destination, such as a second airport. Each trip can include multiple legs between the departure destination and the arrival destination. For example, a particular trip can include three or more legs.

As shown in FIG. 1, two trips 12 and 14 have been determined (for example, generated by the scheduling control unit 102). Each trip 12 and 14 is a work unit that is to be assigned between the different crew members A and B. The trip 12 spans between Day 2 and Day 3, while the trip 14 spans between Day 5 and Day 6. Crew member A is unavailable for assignment on Days 1, 2, and 5. Crew member B is unavailable for assignment on Days 1 and 6. FIG. 1 further shows crew availability on the different days. For example, there is no crew availability on Day 1.

Crew member B is available to be assigned to trip 12. In particular, trip 12 spans between Days 2 and 3, and Crew member B is available for rostering on those two days.

However, trip 14 spans between Days 5 and 6. Crew member B is available on Day 5, but not on Day 6. Conversely, Crew member A is available on Day 6, but not Day 5. As such, the trip 14 is unassignable (that is, a conflict exists between the determined trip and availability of the crew to be assigned to the determined trip). Therefore, as described herein, one or both of the scheduling control unit, and/or a rostering control unit analyzes the availability of the Crew members A and B, and automatically reconfigures (for example, automatically modifies) the trip 14 into a sub-trip 14a and a sub-trip 14b. The control unit(s) then assigns the sub-trip 14a to Crew member B, and the sub-trip 14b to Crew member A.

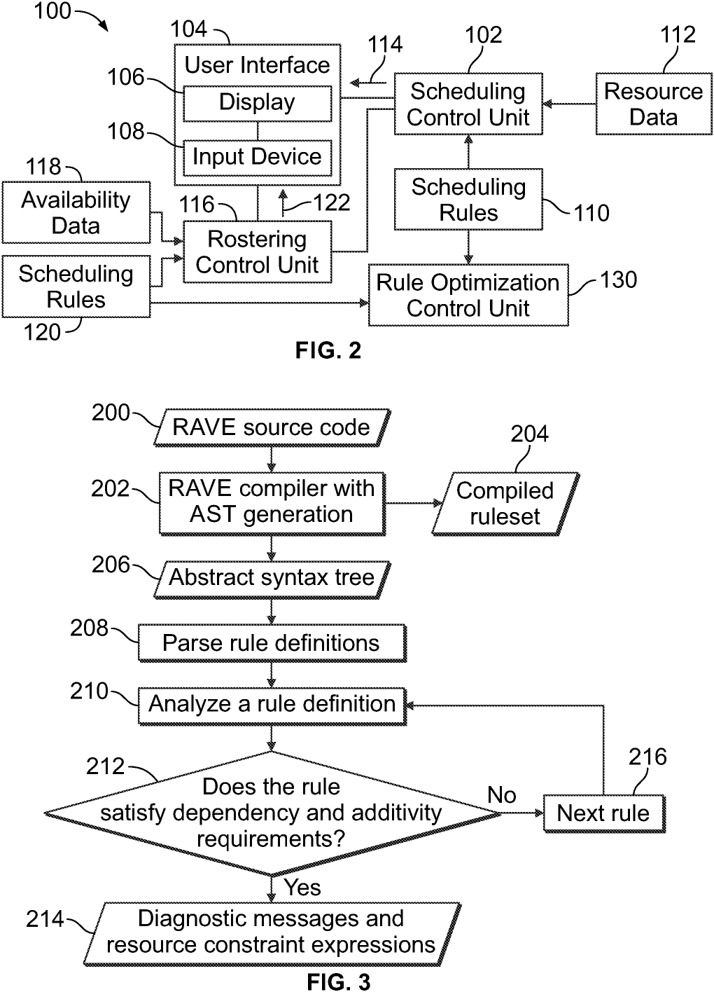

FIG. 2 illustrates a schematic block diagram of a system 100 for scheduling resources, according to an example of the present disclosure. Examples of the resources including personnel, equipment, vehicles, and/or the like. For example, the personnel can be pilots and flight attendants for an aircraft. As another example, the personnel can be operators of vehicles, such as trains, buses, or the like. As another example, the personnel can be medical staff within one or more medical facilities, such as hospitals. As another example, the personnel can be wait staff at restaurants.

The system 100 includes a scheduling control unit 102 in communication with a user interface 104, such as through one or more wired or wireless connections. The user interface 104 includes a display 106, such as an electronic monitor or screen, television, or the like, and an input device 108, such as may be or include a keyboard, mouse, stylus, touchscreen interface, and/or the like. In at least one example, the user interface 104 is part of a computer workstation, such as can include the scheduling control unit 102. As another example, the user interface 104 can be a handheld device, such as a smart phone, smart tablet, or the like.

The scheduling control unit 102 receives scheduling rules 110 and resource data 112. The scheduling rules 110 and the resource data 112 can be input into the scheduling control unit 102, such as via the user interface 104, another computer, and/or the like. In at least one example, the scheduling control unit 102 receives the scheduling rules 110 and the resource data 112 from a network, such as a private network, a public network, the Internet, and/or the like.

The resource data 112 includes data regarding all of the resources that are to be scheduled. Examples of the resources include human beings, such as vehicle operators (such as pilots and flight attendants), maintenance crew, vehicles, and/or the like.

The scheduling rules 110 include resource constraints (for example, upper and/or lower limits) for scheduling the resources. As an example, a scheduling rule 110 is a certain amount of block time that can be flown by a pilot in a day. For example, a scheduling rule 110 dictates that a pilot cannot fly more than 8 hours of block time in a day. As another example, a scheduling rule 110 is a pilot can fly a certain number of flight legs (such as four) in a day. As another example, a scheduling rule 110 is that a pilot must fly a certain number of flights in a given month (such as at least five flights per month). The scheduling rules 110 can be determined by a particular entity, such as an airline operator, a regulatory agency, such as the FAA, a labor union, and/or the like. The scheduling rules 110 can be determined by multiple entities and dictate upper and/or lower limits for various aspects for scheduling the resources.

The system 100 also includes a rostering control unit 116 in communication with the user interface 104, and the scheduling control unit 102 through one or more wired or wireless connections. In at least one example, the rostering control unit 116 is separate and distinct from the scheduling control unit 102. As another example, the scheduling control unit 102 and the rostering control unit 116 are part of a common computing or processing device. The system 100 can also include a separate and distinct optimization control unit, or each of the scheduling control unit 102 and the rostering control unit 116 can include optimization capability. That is, the optimization can be performed by the scheduling control unit 102 and/or the rostering control unit 116. For example, the scheduling control unit 102 and the rostering control unit 116 can be part of a single processor, integrated circuit, and/or the like. In at least one example, a single control unit can perform the operation of both the scheduling control unit 102 and the rostering control unit 116. As described herein, the scheduling control unit 102 is configured to determine trips (such as one or more legs of a journey between a departure location and an arrival location), and the rostering control unit 116 receives data regarding the trips, and determines a roster for crew members to assign to such trips.

The rostering control unit 116 receives availability data 118 for the crew members (such as shown in FIG. 1). The availability data 118 can be within a memory of, and/or in communication with, the rostering control unit 116. The rostering control unit 116 also receives scheduling rules 120 for the crew members. The scheduling rules 120 can also be within a memory of, and/or in communication with, the rostering control unit 116. The scheduling rules 120 can be the same as the scheduling rules 110. In at least one example, the rostering control unit 116 receives the scheduling rules 110, but not the scheduling rules 120.

The availability data 118 and the scheduling rules 120 (or optionally 110) can be input into the rostering control unit 116, such as via the user interface 104, another computer, and/or the like. In at least one example, the rostering control unit 116 receives the availability data 118 and the scheduling rules 120 from a network, such as a private network, a public network, the Internet, and/or the like.

In operation, the scheduling control unit 102 analyzes the scheduling rules 110 to identify the various resource constraints embedded within or otherwise part of the scheduling rules 110. As noted, the limits can be upper limits (for example, a pilot cannot log more than 8 hours of block time in a day), and/or lower limits (for example, a pilot must fly at least five flights in a month). The scheduling control unit 102 identifies the various limits within the scheduling rules 110. After determining the various limits within the scheduling rules 110, the scheduling control unit 102 applies the scheduling rules to the resource data 112 to determine various schedule options for the resources as set forth in the resource data 112. However, by identifying the limits within the scheduling rules 110, the scheduling control unit 102 refrains from generating schedule options that violate (for example, are in excess of upper limits or are below lower limits) the limits. In this manner, the scheduling control unit 102 efficiently determines the schedule options in a much faster manner than if all possible scheduling permutations were generated. As such, computing time and power are conserved, and the scheduling control unit 102 vastly improves the efficiency and operation of a business rules engine, such as RAVE.

The scheduling control unit 102 determines the trips based on the aforementioned constraints. Referring to FIGS. 1 and 2, the scheduling control unit 102 determines the trips 12 and 14. At this point, the trips 12 and 14 are anonymous in that the Crew members A and B have not been specifically assigned to the trips 12 and 14.

After the scheduling control unit 102 determines the trips 12 and 14, the rostering control unit 116 receives data, such as from the scheduling control unit 102, indicative of the trips 12 and 14. The rostering control unit 116 automatically analyzes the trips 12 and 14 (without human intervention), and determines if there are any conflicts between the trips 12 and 14 and the availability of the Crew members A and B. In this case, the rostering control unit 116 assigns trip 12 to Crew member B, but determines the trip 14 is unassignable. The rostering control unit 116 further determines that Crew member B is available on Day 5, and that Crew member A is available on Day 6. In response, the rostering control unit 116 automatically splits the trip 14 into the sub-trip 14a and the sub-trip 14b. Next, the rostering control unit 116 automatically assigns the sub-trip 14a to Crew member B, and the sub-trip 14b to Crew member A, thereby satisfying the rostering for all legs of the trip 14, as originally determined by the scheduling control unit 102. The scheduling control unit 102 further analyzes the scheduling rules 120 (or optionally 110) to determine that the determined roster for the Crew members A and B does not violate any such rules.

In at least one example, the rostering control unit 116 receives the trips 12 and 14 from the scheduling control unit 102. The rostering control unit 116 then operates to create one or many rosters for crew members A and B. For crew member B, the rostering control unit 116 creates a roster with trip 12 assigned, but there is no way to assign trip 14 to a crew member. Hence the input to a control unit (such as the rostering control unit 116 or a separate optimization control unit) includes a roster for crew member B with trip 12 assigned, trip 14 unassigned, and an option having trip 12 unassigned. The control unit then selects a combination of trips and rosters that cover all the flights. For example, the control unit must select trip 14 unassigned (since there are no options) and cover trip 12 by selecting the roster for crew B. The control unit also collects feedback information for the scheduling control unit 102, which prompts the scheduling control unit 102 to generate alternative trips that cover the flights in trip 14, because it was not possible to roster trip 14. In this example, the rostering control unit 116 may not split or reconfigure any trips. Instead, the scheduling control unit 102 may split or reconfigured trips as a response to the feedback received from the optimization routine.

In at least one example, the rostering control unit 116 may not modify any trips and/or select trips to be presented to the user. Instead, the rostering control unit 116 may create new alternative rosters for crew given a set of available trips. The scheduling control unit 102 and the rostering control unit 116 can cooperate to simultaneously select an optimal combination of trips and rosters. Optionally, another separate and distinct optimization control unit simultaneously select an optimal combination of trips and rosters. In such an example, a separate and distinct optimization control unit can be in communication with both the scheduling control unit 102 and the rostering control unit 116.

In at least one example, the rostering control unit 116 may not modify trips. Instead, alternative trips are generated by the scheduling control unit 102 in a subsequent iteration based on feedback from an optimization routine. The rostering control unit 116 then receives the alternative trips, and the process repeats.

In at least one example, the rostering control unit 116 determines a plurality of rosters for crew members, such as Crew members A and B. The plurality of rosters can include reconfigured (for example, modified) trips or sub-trips, as described. The plurality of rosters satisfy all scheduling rules and availability for the Crew members A and B. The rostering control unit 116 can then analyze the plurality of rosters. At least control unit (such as a separate optimizer control until, and/or an optimization aspect of the rostering control unit 116) then selects a preferred roster for each crew member. In at least one example, the preferred roster provides optimal harmony among all of the crew members. The optimal harmony is determined by the scheduling rules 120 (and/or 110), ease of travel to particular destinations for the individual crew members, and/or the like.

As described herein, the system 100 is configured to determine rosters of crews, which include a plurality of crew members. The rosters can include information about all activities from a previous planning period for specific crew members, as well as pre-assigned activities that are required by particular scheduling rules, such as vacations, health checks, certain trips, and/or the like.

As described herein, the system 100 includes one or more control units (such as the rostering control unit 116) configured to automatically (without human intervention) assign crew members to trips (which can include multiple legs over multiple days) of one or more vehicles (such as aircraft) to form a roster for the crew members. In at least one example, the control unit(s) is further configured to automatically reconfigure (for example, modify) one or more of the trips in response to determining one or more conflicts between the one or more trips and availability of the crew members for the one or more trips. That is, a conflict arises if there is no availability among the crew members to be assigned such a trip, as originally determined (such as by the scheduling control unit 102). In at least one further example, the control unit(s) is configured to automatically reconfigure the one or more trips by reconfiguring the one or more trips into a plurality of sub-trips (for example, component portions of the originally determined trip).

In at least one example, a RAVE module operating according to RAVE source code is extended to determine the legality and cost of complete crew rosters. In addition to a trip generator (for example, the scheduling control unit 102), the system 100 also includes a roster generator (for example, the rostering control unit 116) configured to generate rosters for crews. The rosters generated for a certain crew can include historic and mandatory (for example, pre-assigned) activities together with different selections of trips. The legality and cost of such rosters can be computed using the extended RAVE module. The rostering control unit 116 discards illegal rosters (that is, those rosters that violate one or more scheduling rules, and are therefore invalid).

In at least one example, the rostering control unit 116 is configured to select a subset of trips together with a subset of crew rosters so that a single roster is selected for each crew and each flight is covered by a trip (either assigned to a crew roster or left unassigned). In a post-processing step, the rostering control unit 116 can save one or more of the determined rosters.

In at least one example, the scheduling control unit 102 operates as a trip generator. In this manner, the scheduling control unit 102 generates legal and efficient trips, which include numerous options and alternatives for trips of each flight that can be planned. The rostering control unit 116 provides a roster generator that generates legal and efficient rosters for the crew members based on trips generated by the scheduling control unit 102. The rostering control unit 116 generates numerous options and alternatives for rosters for crew members. One or both of the scheduling control unit 102 and/or the rostering control unit 116 is further configured as an optimizer to select a subset/combination of trips and rosters such that each flight is covered by either a (unassigned) trip or a roster. Each crew can be assigned exactly one roster, as determined by the rostering control unit 116. The scheduling control unit 102 and/or the rostering control unit 116 can also collects information that is used to guide the scheduling control unit 102 and the rostering control unit 116 in a next iteration of the process described herein.

Prior to the systems and methods described herein, due to size and complexity, runtimes for computer-based scheduling could be several days for a large crew group. A known method generates new rosters by finding shortest paths in a trip network. However, some shortest paths do not comply with permissible rules. An allowability rate (that is, the rate at which a path is permissible according to a rule) can be increased by augmenting a trip network with resource constraints that correspond to additive permissibility rules. Typically, resource constraints are written manually in RAVE as a part of customer specific configuration. Finding suitable rules and deducing the constraints is a challenging and error-prone task. Accordingly, examples of the present disclosure provide systems and methods (such as the system 100 shown in FIG. 2) that automatically detect additive rules through static RAVE code analysis, and then generate new source code for the corresponding resource constraint.

The system 100 achieves computational performance and flexibility. Column generation is a known method for solving a weighted fair share rostering problem. One of the steps of the method is generating new rosters by finding shortest paths in a trip network. After finding a shortest path in the network, an optimizer checks the permissibility of the corresponding roster (in relation to predefined rules). If the roster is permissible, a new path is generated, but this time with impermissible paths excluded. However, solving the shortest path problem several times to get a permissible roster decreases performance considerably.

To avoid impermissible paths, the scheduling control unit 102 and/or the rostering control unit 116 is augmented with resource constraints which correspond to RAVE rules. The resource constraints are limits (either upper or lower limits) identified in the rules. Scheduling and/or rostering options that violate (for example, exceeding an upper limit or being less than a lower limit) are not generated by the scheduling control unit 102 and/or the rostering control unit 116. Not every rule can be expressed as a resource constraint, but a significant portion can. As an example, the rule satisfies the following: First, the rule condition has a form left_hand_side and right_hand_side. Second, the expressions for right_hand_side and rule validity may depend on a crew and a bid group, but may not depend on a roster or trips in the roster. Third, the expression for left_hand_side may not depend on a crew or a bid group, but should be additive over trips in the roster (for example, consumption of a roster is a sum of the consumptions of trips in the roster). A special case is an edge resource constraint, where left_hand_side does not have to be additive over trips, but is additive over edges (connections between two adjacent trips).

Examples of the present disclosure provide systems and methods for solving complex crew resource optimization problems in a computationally efficient manner using resource constraints combined with a business rules engine, such as RAVE. The systems and methods described herein address the currently resource-heavy and manual process of identifying and implementing customer-specific resource constraints for crew resource optimization.

In at least one example, the scheduling control unit 102 and/or the rostering control unit 116 is configured to determine the resource constraints by analyzing an abstract syntax tree of business engine scheduling source code, identify additive rules, and generate resource constraint definitions as business engine scheduling expressions. For example, the scheduling control unit 102 and/or the rostering control unit 116 analyzes an abstract syntax tree of business engine scheduling and/or rostering source code (such as RAVE source code), finds additive rules and generates resource constraint definitions as RAVE expressions. In at least one example, the scheduling control unit 102 and/or the rostering control unit 116 parses the abstract syntax tree of each RAVE rule. The scheduling control unit 102 and/or the rostering control unit 116 parses the syntax tree and checks the dependency of the rule condition as well as the dependencies of the RAVE variables used in the rule. If the condition statement and the RAVE variables fulfill the conditions, the rule can be written as a resource constraint. Next, the scheduling control unit 102 and/or the rostering control unit 116 generates the RAVE code for the identified resource constraints by parsing the abstract syntax trees for the identified rules and translating them back to RAVE code.

In at least one example, the scheduling control unit 102 outputs scheduling data 114 to the user interface 104. The scheduling data 114 includes the trips. The scheduling data 114 includes the scheduling options for the resources identified in the resource data 112. The user interface 104 may show at least portions of the scheduling data 114 on the display 106. The user interface 104 has an electronic display 106. The user interface is in communication with the scheduling control unit 102. The scheduling control unit 102 is configured to show one or more of the scheduling options on the electronic display 106.

In at least one example, the rostering control unit 116 outputs roster data 122 to the user interface 104. The roster data 122 includes one or more rosters for scheduled trips (which may include sub-trips, as described herein). The roster data 122 can include multiple roster options for the crew members. The rostering control unit 116 (such as an optimization portion thereof), or a separate and distinct control unit (such as an optimization control unit) can identify a preferred roster among the plurality of roster options. In at least one example, the rostering control unit 116 automatically selects the preferred roster. As another example, the rostering control unit 116 identifies the preferred roster, and allows an individual to select among the roster options. The user interface 104 may show at least portions of the roster options on the display 106.

In at least one example, the system 100 also includes a rule optimization control unit 130. The rule optimization control unit 130 can be separate and distinct from the scheduling control unit 102 and the rostering control unit 116. Optionally, the scheduling control unit 102 or the rostering control unit 116 can include the rule optimization control unit 130. As another example, a single control unit can be configured to perform the operations of each of the scheduling control unit 102, the rostering control unit 116, and the rule optimization control unit 130.

The rule optimization control unit 130 receives rules regarding one or more plans. The plans can be for scheduling resources, rostering crews, and/or the like, as described herein. For example, the rule optimization control unit 130 receives he scheduling rules 110 and the scheduling rules 120.

The rule optimization control unit 130 substantially increases computing efficiency, decreases computing time, and also decreases computing power. As such, the rule optimization control unit 130 provides a specialized computing device that is configured to improve computing efficiency. Typically, runtimes can last many hours, or even days. The rule optimization control unit 130 substantially improves performance by substantially decreasing runtimes, thereby decreasing development times and costs.

In at least one example, the rule optimization control unit 130 is configured to perform static analysis of RAVE code with runtime information. The rule optimization control unit 130 is able to deduce properties of values, such as bounds, monotonicity, and the like, thereby limiting or otherwise reducing a search space.

As an example, the rule optimization control unit 130 receives plan rules, such as the scheduling rules 110 and/or the scheduling rules 120. In response, the rule optimization control unit 130 determines a rule, such as a maximal block time rule, is monotonous, as a partial trip violating such rule cannot be extended into a legal complete trip by adding legs. In contrast, the rule optimization control unit 130 further determines that a partial trip can be extended into a legal tip if a rule stating that trips must start and end at the same location is violated.

The rule optimization control unit 130 can also specialize rules for current conditions. As an example, rules relating to extra load during a holiday can be disregarded during the rest of the year, or rules for international flights can be disregarded in purely domestic plans. That is, the rule optimization control unit 130 disregards rules that are not applicable to a current plan. By disregarding and discarding inapplicable rules for a current plan (whether scheduling of resources, rostering of crews, and/or the like), the rule optimization control unit 130 decreases computing time and power, thereby substantially increasing the operational efficiency.

In at least one example, the rule optimization control unit 130 automatically creates rules that guide a search more efficiently based on current conditions of a particular plan. The rule optimization control unit 130 can also create filters taking partial chains as inputs, returning properties a leg of a trip must fulfill to be a possible legal continuation. The rule optimization control unit 130 can also check manually developed resource constraints against actual rules. Further, the rule optimization control unit 130 can also gain access to refined versions of rules, making it unnecessary for developers to manually write resource constraints.

In typical execution of RAVE code, an optimizer cannot deduce higher level information about variables. Instead, the optimizer has to try many assignments to determine, for instance, which trips can be combined on a roster, and cannot use properties like bounds or monotonicity. A known dependency analysis is imprecise, as it considers all possible plans and settings. In addition to writing rules, developers typically manually supply a resource formulation of certain rules. Mismatches in this dual specification happen due to human error, and cause performance and quality issues. In addition, dual descriptions increases a maintenance burden.

In contrast to interacting with a RAVE program as a black box, the rule optimization control unit 130 analyzes rules for a particular plan (such as scheduling of resources, rostering of crews, and/or the like) together with runtime information to determine higher level information. For example, a rule exists stating that a maximum connection time between two flights is 48 hours. Typically, an interface to RAVE would test all combinations of flights. In contrast, the rule optimization control unit 130 receives the rule, determines the structure of the rule, and then filters out numerous combinations of flights of combinations, thereby reducing an O(n²) operation to O(n log n).

The rule optimization control unit 130 analyzes rules in relation to data that is known at runtime. As an example, a trip (for example, a flight) is considered international if the trip contains at least one international leg (such as a flight from Chicago, Illinois to Dublin, Ireland). Further, a rule exists that limits duty time to 11 hours for international trips, but only 10 hours for domestic trips. If a plan (such as flights over a period of a week) is entirely domestic, the lower limit of 10 hours can be globally applied, and the rule regarding the international trips can be discarded for such plan. That is, the rule optimization control unit 130 analyzes the proposed plan, which does not include any international flights, and then discards the rule regarding the international flights. The rule optimization control unit 130 can then refrain from any combinations that would include such international rule, thereby reducing computing time and power.

Accordingly, the rule optimization control unit 130 automatically generates resource constraints, which relieves programmers of this time consuming and error prone task. The rule optimization control unit 130 automatically generates resource constraint (for example, by discarding rules that do not apply to a particular plan, such as scheduling of resources and/or rostering of crews) in runtime (instead of relying on previously established rules), which leads to precise resource constraints.

In contrast to prior operations, in which optimizers obtain cost and legality information for given activities from a compiled ruleset, as well as some dependency information, the rule optimization control unit 130 allows information from the ruleset to be analyzed in relation to runtime data to determine properties that can guide a determination of plan (such as schedules, rostering, and/or the like) in a highly efficient and precise manner.

The rule optimization control unit 130 analyzes a set of rules in relation to a plan during runtime when more information is known. In the past, simplification of rules was performed when the rules are compiled (that is, before runtime). Therefore, optimization was defensive in the sense that all possible combinations of parameters and data were considered during runtime. Further, in the past, an optimizer guessed certain features of a ruleset, based on behavior of legality and costs, with a RAVE interface answering only with TRUE/FALSE on legality questions for specific chains. In contrast, the rule optimization control unit 130 analyzes rules during runtime static, and therefore determines more specific information on which legs for a trip can be legally added, thereby greatly reducing the number of questions asked. The rule optimization control unit 130 analyzes a plan and is able to discard numerous rules based on various parameters of the plan.

In at least one example, various operations can be automatically performed based on selected scheduling and roster options. For example, aircraft can be automatically staffed and/or operated based on schedules from the scheduling and/or roster options, as determined by the scheduling control unit 102, the rostering control unit 116, and/or the rule optimization control unit 130. In at least one example, the scheduling control unit 102, the rostering control unit 116, and/or the rule optimization control unit 130 automatically selects schedules and/or rosters from the scheduling and/or roster options based on one or more parameters (for example, lowest cost of labor, regular number of work days for all personnel, least amount of off time, and/or the like). In at least one example, the scheduling control unit 102 automatically selects schedules from the scheduling options for all of the resources and one or more systems, such as vehicles, having one or more operations that are automatically operated based on the automatically selected schedules. Optionally, the scheduling control unit 102, the rostering control unit 116, and/or the rule optimization control unit 130 may not automatically select schedules and/or rosters from the scheduling and/or roster options. Also, optionally, operations may not be automatically performed based on selected schedules and/or rosters.

As an example, an airline may have a rule that a trip, which includes a plurality of flights, may not mix flights that arrive at and/or depart from a particular airport, as well as international flights. For such rule, one or more illegal chains violating such rule can be generated. The rule optimization control unit 130 analyzes a plan in relation to such rule. For example, the plan is for scheduling flights and/or rostering crew for the trip. During runtime, the rule optimization control unit 130 determines that there are no international flights for the trip. As such, the optimization control unit 130 then ignores the aforementioned rule, thereby reducing the ruleset to only the applicable rules.

As another example, there may be numerous rule failures. In this example, the rule optimization control unit 130 can effectively create two partially overlapping subsets of flights, one containing all flights that are not international, and one set that contains no flight touching the particular airport. Flights that are neither international nor touching the specific airport will belong to both sets. The rule optimization control unit 130 can then split a trip generation into two parts, one over each subset. As no subset contains a combination of flights that violate the rule, the rule optimization control unit 130 can then determine that no subset contains a combination of flights that violate the rule. Accordingly, there are no more rule failures.

As described herein, the system 100 includes the scheduling control unit 102 configured to generate scheduling options for resources of a service, such as flight crew, maintenance crew, gate agents, and the like of flights of aircraft. For example, the resources include pilots, flight attendants, and a plurality of aircraft, and the service includes flights of the plurality of aircraft between various airports. The scheduling control unit 102 is configured to analyze scheduling rules for the resources, and determine resource constraints as dictated by the scheduling rules. The resource constraints include one or both of upper limits or lower limits of the scheduling rules. The scheduling control unit 102 generates the scheduling options in accordance with the resource constraints. That is, the scheduling control unit 102 refrains from generating any scheduling option that violates the resource constraints.

As described herein, the system 100 includes the rostering control unit 116 configured to automatically determine one or more rosters for a plurality of crew members based on trips, such as can be determined by the scheduling control unit 102. The rostering control unit 116 is configured to automatically (without human intervention) analyze the trips and automatically (without human intervention) determine one or more rosters for the crew members based on the trips. In at least one example, if the crew members are unavailable (and/or qualified, or otherwise restricted) for one or more trips (that is, the trip(s) conflict with crew availability), the rostering control unit 116 automatically modifies the trip(s) into a plurality of sub-trips that are assignable to one or more of the crew members. The rostering control unit 116 then assigns the available crew members to the sub-trips.

As also described herein, the system 100 includes the rule optimization control unit 130, which is configured to analyze a ruleset for a plan (such as scheduling, rostering, and/or the like) and reduce applicable rules within the ruleset based on the plan. In at least one example, the rule optimization control unit 130 analyzes the ruleset to reduce to the applicable rules during runtime, as opposed to compile time.

As described herein, in at least one example, the system 100 includes one or more control units including one or more processors. The one or more controls units is configured to receive a compiled ruleset including rules, receive a plan for a trip for one or more vehicles, determine if the rules are applicable to the plan, and discard each of the plurality of rules that is not applicable to the plan.

In at least one example, the one or more control units is configured to determine if the rules are applicable to the plan and discard each of the plurality of rules are not applicable to the plan during runtime.

The plan can include one or more resources and/or crew rosters for the trip. As a further example, the one or more control units is further configured to schedule resources after discarding the rules that are not applicable to the plan. As another example (or a further example), the one or more control units is further configured to determine one or more rosters of crew members for the trip after discarding the rules that are not applicable to the plan.

In at least one example, the one or more vehicles includes one or more aircraft, and the trip includes a plurality of flights between different airports. The rules can include scheduling rules (for resources) and/or rostering rules (for crew members), for example.

In at least one example, a single control unit can perform the operations of the scheduling control unit 102, the rostering control unit 116, and the rule optimization control unit 130. For example, the scheduling control unit 102, the rostering control unit 116, and the rule optimization control unit 130 can be part of a common control unit. As such, the system 100 includes one or more control units configured to operate as described herein.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the scheduling control unit 102, the rostering control unit 116, and the rule optimization control unit 130 may be or include one or more processors that are configured to control operation, as described herein.

The scheduling control unit 102, the rostering control unit 116, and the rule optimization control unit 130 are configured to execute a set of instructions that are stored in one or more data storage units or elements (such as one or more memories), in order to process data. For example, scheduling control unit 102, the rostering control unit 116, and the rule optimization control unit 130 may include or be coupled to one or more memories. The data storage units may also store data or other information as desired or needed. The data storage units may be in the form of an information source or a physical memory element within a processing machine.

The set of instructions may include various commands that instruct the scheduling control unit 102, the rostering control unit 116, and the rule optimization control unit 130 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the scheduling control unit 102, the rostering control unit 116, and the rule optimization control unit 130. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the scheduling control unit 102, the rostering control unit 116, and the rule optimization control unit 130 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 3 illustrates a flow chart of a method, according to an example of the present disclosure. Referring to FIGS. 2 and 3, at 200, RAVE source code is generated. One or more control units, such as the scheduling control unit 102, the rostering control unit 116, and/or the rule optimization control unit 130, receives RAVE source code at 202. In at least one example, the one or more control units include a RAVE compiler with abstract syntax tree (AST) generation. At 204, a compiled ruleset is generated, such as by one or more control units.

At 206, the control unit(s) analyzes the abstract syntax tree of the RAVE source code to identify rule definitions (that is, the rules). At 208, the control unit(s) parses the rule definitions. At 210, the control unit(s) analyzes a rule definition. At 212, the control unit(s) determines if the rule satisfies dependency and additivity requirements. For example, an additivity requirement is in relation to an upper limit. As an example, a rule requires that a pilot does not exceed 8 hours block time in a day. As another example, a rule requires at least 5 flights in a month. As another example, a rule requires no more than 4 flight legs in a day. If, at 212, the rules satisfied dependency and additivity requirements, the method proceeds to 214, at which control unit(s) outputs diagnostic messages, and resource constraint expressions. If, however, the rule does not satisfy the additivity and dependency requirements, the method proceeds to 216, at which the control unit(s) analyzes the next rule, and the method returns to 210.

A dependency rule relates to what a specific expression depends upon. For example, block time is summed for each trip in a predetermined time period, such as a month. The block time of each trip depends only on the trip itself and the rule can be expressed as a resource constraint. As another example, an individual may fly at most two night trips in a month. A trip is considered a night trip if an individual works across a predefined time in personal acclimatised time (commonly called one’s body clock). The personal acclimatised time is a function of the time of nightly rest for a past week. Even though the rule can be expressed as a sum of a per trip value, the value that is summed (if a trip is considered a night trip) depends on more than the trip itself or its immediate predecessor. Hence, the trip value may not be pre-computed as it depends on the surrounding schedule and cannot be expressed as a sum of something purely trip-dependent. Therefore, such rule cannot be expressed as a simple additive resource constraint.

As shown and described, in at least one example, the control unit(s) analyzes the abstract syntax tree of business engine scheduling source code (such as RAVE source code), identifies additive rules, and generates resource constraint definitions as business engine scheduling (for example, RAVE) expressions. In at least one example, the control unit(s) parses the abstract syntax tree of each business engine scheduling (for example, RAVE) rule. The control unit(s) parses the abstract syntax tree and checks the dependency of the rule condition as well as the dependencies of business engine scheduling variables used in the rule. If the condition statement and the business engine scheduling variables fulfill predefined conditions, the rule can be written as a resource constraint. In a final step, the control unit(s) generates code for the identified resource constraints by parsing the abstract syntax trees for the identified rules and translating them back to the business engine scheduling source code.

In at least one example, after the compiled ruleset is determined, such as at 204, the control unit(s) (such as the rule optimization control unit 130) analyzes the ruleset in relation to a plan (such as for resources, crew rostering, and/or the like). By analyzing the ruleset in relation to the plan, the control unit(s) can then reduce the ruleset by discarding rules that do not apply to the plan (for example, inapplicable rules). For example, if a plan relates to trips during a time period, such as a week, do not include any international flights, the control unit(s) discards or otherwise removes rules regarding international flights from the ruleset. The control unit(s) analyzes the ruleset during runtime (in contrast to compile time) in order to discard inapplicable rules. By reducing the total number of rules to only those that are appliable to the plan, the control unit(s) reduced overall computing time and power consumption.

Examples of the subject disclosure provide systems and methods that allow large amounts of data to be quickly and efficiently analyzed by a computing device. For example, the scheduling control unit 102, the rostering control unit 116, and/or the rule optimization control unit 130 can analyze various aspects of resources, trips, and scheduling rules. As such, large amounts of data, which may not be discernable by human beings, are being tracked and analyzed. The vast amounts of data are efficiently organized and/or analyzed by the scheduling control unit 102, the rostering control unit 116, and/or the rule optimization control unit 130, as described herein. The scheduling control unit 102, the rostering control unit 116, and/or the rule optimization control unit 130 analyze the data in a relatively short time in order to quickly and efficiently determine scheduling and rostering options in a relatively short time. A human being would be incapable of efficiently analyzing such vast amounts of data in such a short time. As such, examples of the subject disclosure provide increased and efficient functionality, and vastly superior performance in relation to a human being analyzing the vast amounts of data.

Identifying rules satisfying various requirements (for example, upper and lower limits), and writing corresponding resource constraints is a non-trivial, time-consuming, and error-prone task for humans, yet essential to get maximum performance in relation to a column generation method. Very few people have the required skills to effectively perform such tasks. The systems and methods described herein automatically (that is, without human intervention), efficiently, and effectively perform such tasks.

In at least one embodiment, components of the system 100 include one or more control units, such as the scheduling control unit 102, the rostering control unit 116, and/or the rule optimization control unit 130, which provide and/or enable a computer system to operate as a special computer system for analyzing plans, such as schedules and rosters. The scheduling control unit 102, the rostering control unit 116, and/or the rule optimization control unit 130 greatly improve upon business engine scheduling software by greatly decreasing computing time and power to efficiently and effectively determine schedules for various resources and rosters for crew members.

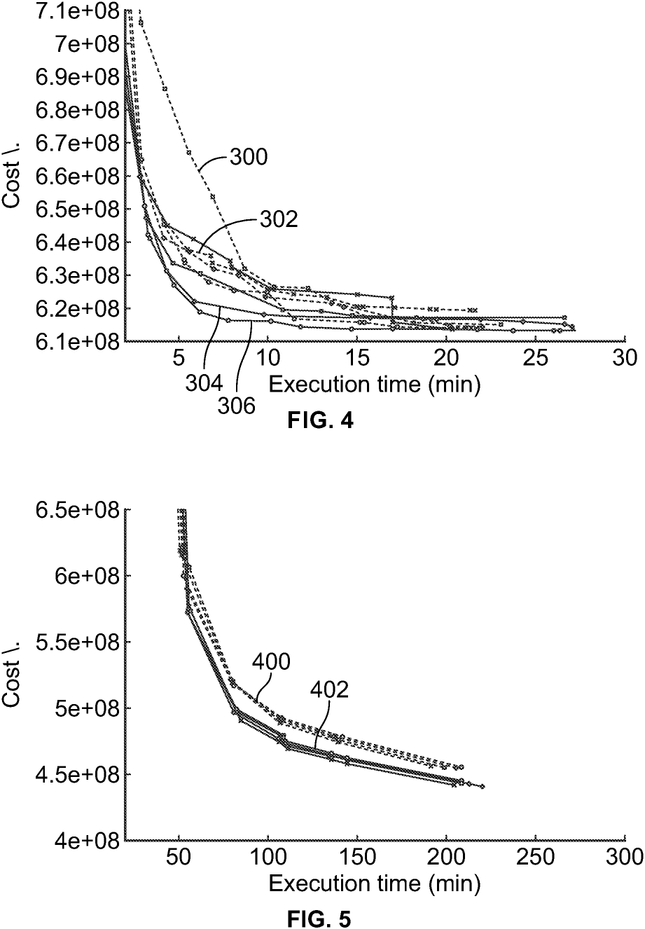

FIG. 4 illustrates a chart of execution time in relation to cost for a system for scheduling resources, according to an example of the present disclosure. As shown in FIG. 4, examples of the present disclosure provide systems and methods that vastly improve time and costs by adding identified resource constraints to the model. The curves 300 and 302, for example, correspond to different permutations of the same run (that is, they use different random seeds which typically result in different solution paths). The curves 304 and 306, for example, correspond to the same runs but with the resource constraints generated by the scheduling control unit 102. It has been found that adding resource constraints provides better solutions faster (notably, the curves 304 and 306 are below the curves 300 and 302).

FIG. 5 illustrates a chart of execution time in relation to cost for a system for scheduling resources, according to an example of the present disclosure. The curves 400 correspond to runs where no resource constraints are used. The curves 402 correspond to runs in which resources constraints (for example, limits identified in the rules -- scheduling options that violate such limits are not generated) are added by the scheduling control unit 102. It has been found that the scheduling control unit 102 determining the resource constraints (that is, the limits of the rules), and using such resource constraints when determining scheduling options provides better solutions.

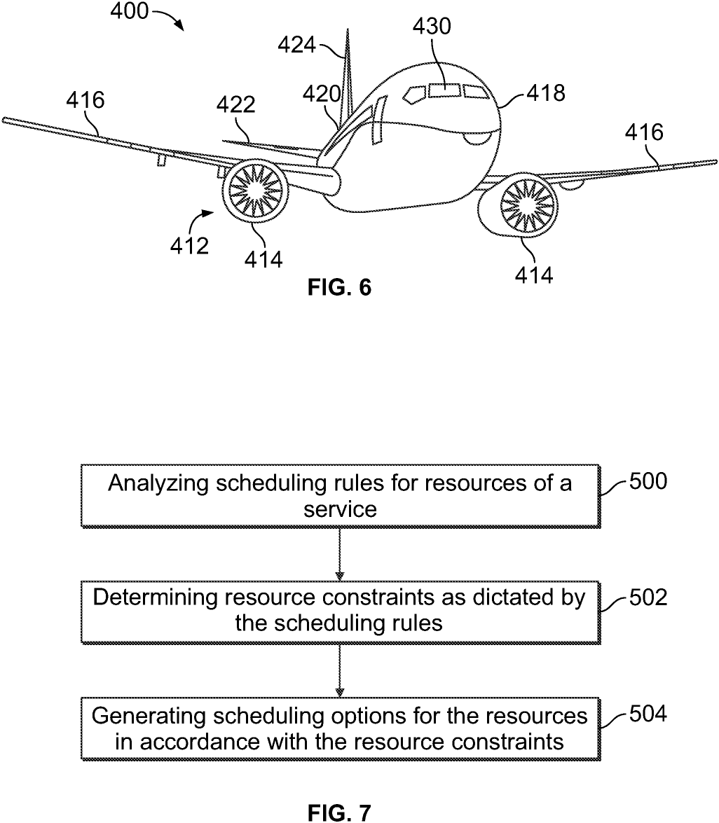

FIG. 6 illustrates a perspective front view of an aircraft 400, according to an example of the present disclosure. The aircraft 400 includes a propulsion system 412 that includes engines 414, for example. Optionally, the propulsion system 412 may include more engines 414 than shown. The engines 414 are carried by wings 416 of the aircraft 400. In other embodiments, the engines 414 may be carried by a fuselage 418 and/or an empennage 420. The empennage 420 may also support horizontal stabilizers 422 and a vertical stabilizer 424. The fuselage 418 of the aircraft 400 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 400. It is to be understood that the aircraft 400 can be sized, shaped, and configured differently than shown in FIG. 6.

Referring to FIGS. 1-6, and the scheduling control unit 102 is configured to determine scheduling options for flights of various aircraft, such as the aircraft 400. The rostering control unit 116 is configured to determine rosters for crew members to staff the aircraft schedules for various trips. The scheduling control unit 102 can schedule resources for hundreds or more aircraft. Similarly, the rostering control unit 116 can determine rosters for dozens, hundreds, or more crew members. The aircraft 400 itself can be a resource identified in the resource data. One or more scheduling rules can apply to the aircraft, such as total flight time in a predefined period of time, flight time until a particular maintenance operation, and/or the like.

In at least one other example, the scheduling control unit 102, the rostering control unit 116, and/or the rule optimization control unit 130 are configured to determine scheduling and/or roster options for trips of various other vehicles, such as trains, buses, watercraft, spacecraft, and/or the like. In at least one other example, the scheduling control unit 102 and/or the rostering control unit 116 is configured to determine scheduling options and/or roster options for various other settings, such as staffing within businesses, hospitals, and/or the like.

FIG. 7 illustrates a flow chart of a method, according to an example of the present disclosure. The method includes analyzing 500, by a scheduling control unit including one or more processors, scheduling rules for resources of a service; determining 502, by the scheduling control unit, resource constraints as dictated by the scheduling rules; and generating 504, by the scheduling control unit, scheduling options for the resources in accordance with the resource constraints.

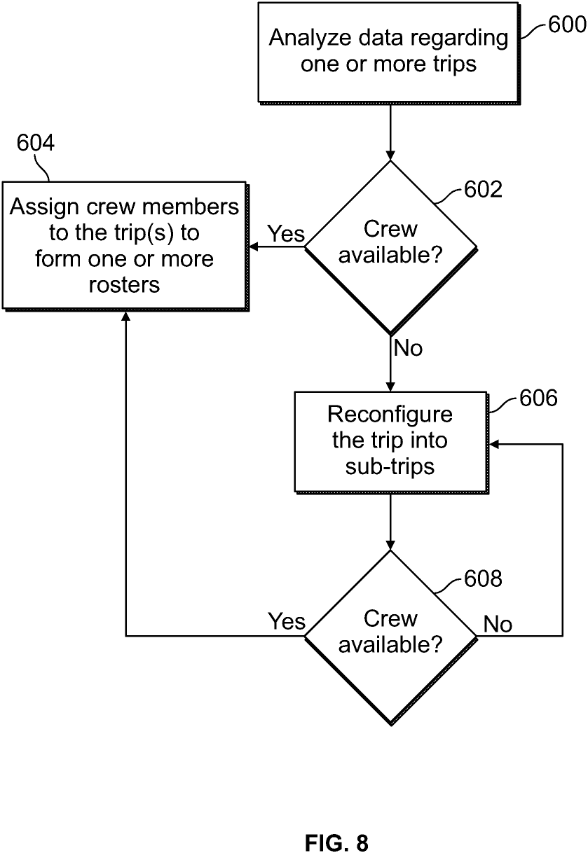

FIG. 8 illustrates a flow chart of a method, according to an example of the present disclosure. The method includes analyzing 600, by one or more control units (such as the rostering control unit 116, shown in FIG. 2), data regarding one or more trips. The trip(s) can be automatically determined, such as by the scheduling control unit 102 (shown in FIG. 1). At 602, the control unit(s) determines if crew members are available for the trip(s). If so, the method proceeds from 602 to 604, at which the rostering control unit 116 automatically (without human intervention) assigns one or more crew members to the one or more trips to form one or more rosters. If, however, crew is not available for the trip(s) at 602 (that is, a conflict exists between the trip(s) and availability of crew members), the rostering control unit 116 automatically (without human intervention) reconfigures the trip(s), such as by generating new trip(s), and/or splitting initially generated trip(s) into sub-trips at 606. At 608, the rostering control unit 116 again determines if crew members are available for the sub-trips. If not, the method returns to 606 (for example, each sub-trip is further reconfigured into another sub-trip or additional sub-trips). If, however, there is crew availability for the sub-trips at 606, the method proceeds from 608 to 604.

In at least one example, trips and rosters are selected simultaneously. Optionally, the trips and rosters can be selected at different times.

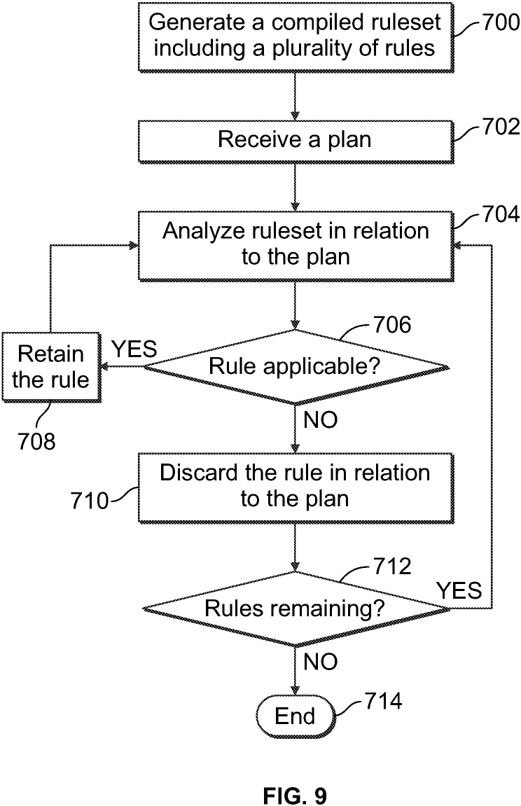

FIG. 9 illustrates a flow chart of a method, according to an example of the present disclosure. At 700, a compiled ruleset including rules is generated, such as by one or more control units. At 702, one or more control units (such as the rule optimization control unit 130 shown in FIG. 2) receives a plan. In at least one example, the plan related to all flights that are to be covered by one or more trips. As another example, the plan can be for one or more trips that are to be assigned to rosters for specific crew members. The plan can relate to scheduling of resources, rostering of crews, and/or the like. For example, a trip can include numerous flights among various airports over a period of a day, numerous days, a week, a month, or the like.

In at least one example, the plan can be different in relation to different issues or problems. For pairing, the plan can include a schedule for several aircraft, and which of the flights of the aircraft are included in a current planning conflict or other such problem. The plan can also include data regarding flights that need not be assigned, but may be used for positioning flights. Such flights may be operated by different airlines. The plan may also include information about other vehicles, such as buses, trains, taxis, and/or the like, which may be used for positioning.

At 702, the control unit(s) analyzes the ruleset in relation to the plan, such as during runtime. At 706, the control unit(s) determines if a particular rule within the ruleset is applicable to the plan. If so, the method proceeds from 706 to 708, at which the control unit(s) retains the particular rule within the ruleset. The method then returns to 704.

If, however, the particular rule is not applicable to the plan at 706, the method proceeds from 706 to 710, at which the control unit(s) discards the particular rule in relation to the plan, thereby reducing the ruleset to only the applicable relevant rules. In this manner, overall computing time and power consumption for determining the plan is substantially reduced.

At 712, the control unit(s) determines if any rules within the ruleset remain to be analyzed. If so, the method returns to 704. If not, the method ends at 714.

Further, the disclosure comprises examples according to the following clauses:

Clause 1. A system comprising:
one or more control units including one or more processors, wherein the one or more controls units is configured to:
   receive a compiled ruleset including rules,
   receive a plan for a trip for one or more vehicles,
   determine if the rules are applicable to the plan, and
   discard each of the plurality of rules that is not applicable to the plan.

Clause 2. The system of Clause 1, wherein the one or more control units is configured to determine if the rules are applicable to the plan and discard each of the plurality of rules not applicable to the plan during runtime.

Clause 3. The system of Clauses 1 or 2, wherein the plan includes one or both of resources or crew rosters for the trip.

Clause 4. The system of Clause 3, wherein the one or more control units is further configured to schedule resources after discarding the rules that are not applicable to the plan.

Clause 5. The system of Clauses 3 or 4, wherein the one or more control units is further configured to determine one or more rosters of crew members for the trip after discarding the rules that are not applicable to the plan.

Clause 6. The system of any of Clauses 1-5, wherein the one or more vehicles includes one or more aircraft, and wherein the trip includes a plurality of flights between different airports.

Clause 7. The system of any of Clauses 1-6, wherein the rules comprise one or both of scheduling rules or rostering rules.

Clause 8. A method comprising:
receiving, by one or more control units including one or more processors, a compiled ruleset including rules;
receiving, by the one or more control units, a plan for a trip for one or more vehicles;
determining, by the one or more control units, if the rules are applicable to the plan; and
discarding, by the one or more control units, each of the plurality of rules that is not applicable to the plan.

Clause 9. The method of Clause 8, wherein said determining and said discarding occur during runtime.

Clause 10. The method of Clauses 8 or 9, wherein the plan includes one or both of resources or crew rosters for the trip.

Clause 11. The method of Clause 10, further comprising scheduling, by the one or more control units, resources after said determining and said discarding.

Clause 12. The method of Clauses 10 or 11, further comprising determining, by the one or more control units, one or more rosters of crew members for the trip after said determining and said discarding.

Clause 13. The method of any of Clauses 8-12, wherein the one or more vehicles includes one or more aircraft, and wherein the trip includes a plurality of flights between different airports.

Clause 14. The method of any of Clauses 8-12, wherein the rules comprise one or both of scheduling rules or rostering rules.

Clause 15. A non-transitory computer-readable storage medium comprising executable instructions that, in response to execution, cause one or more control units comprising a processor, to perform operations comprising:
receiving a compiled ruleset including rules;
receiving a plan for a trip for one or more vehicles;
determining if the rules are applicable to the plan; and
discarding each of the plurality of rules that is not applicable to the plan.

Clause 16. The non-transitory computer-readable storage medium of Clause 15, wherein said determining and said discarding occur during runtime.

Clause 17. The non-transitory computer-readable storage medium of Clauses 15-16, wherein the plan includes one or both of resources or crew rosters for the trip.

Clause 18. The non-transitory computer-readable storage medium of Clause 17, further comprising scheduling resources after said determining and said discarding.

Clause 19. The non-transitory computer-readable storage medium of Clauses 17 or 18, further comprising determining one or more rosters of crew members for the trip after said determining and said discarding.

Clause 20. The non-transitory computer-readable storage medium of any of Clauses 15-19, wherein the one or more vehicles includes one or more aircraft, wherein the trip includes a plurality of flights between different airports, and wherein the rules include one or both of scheduling rules or rostering rules.

As described herein, examples of the present disclosure provide systems and methods for efficiently and effectively scheduling resources, such as for trips (for example, flights, train, or bus journeys, and/or the like). Further, examples of the present disclosure provide systems and methods that improve efficiency of business rules engine methods for determining plans. Also, examples of the present disclosure provide systems and methods that automatically determine one or more rosters of crew members, such as for various legs of a trip.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
one or more control units including one or more processors, wherein the one or more controls units is configured to:
receive a compiled ruleset including rules,
receive a plan for a trip for one or more vehicles,
determine if the rules are applicable to the plan, and
discard each of the plurality of rules that is not applicable to the plan.

2. The system of claim 1, wherein the one or more control units is configured to determine if the rules are applicable to the plan and discard each of the plurality of rules not applicable to the plan during runtime.

3. The system of claim 1, wherein the plan includes one or both of resources or crew rosters for the trip.

4. The system of claim 3, wherein the one or more control units is further configured to schedule resources after discarding the rules that are not applicable to the plan.

5. The system of claim 3, wherein the one or more control units is further configured to determine one or more rosters of crew members for the trip after discarding the rules that are not applicable to the plan.

6. The system of claim 1, wherein the one or more vehicles includes one or more aircraft, and wherein the trip includes a plurality of flights between different airports.

7. The system of claim 1, wherein the rules comprise one or both of scheduling rules or rostering rules.

8. A method comprising:
receiving, by one or more control units including one or more processors, a compiled ruleset including rules;
receiving, by the one or more control units, a plan for a trip for one or more vehicles;
determining, by the one or more control units, if the rules are applicable to the plan; and
discarding, by the one or more control units, each of the plurality of rules that is not applicable to the plan.

9. The method of claim 8, wherein said determining and said discarding occur during runtime.

10. The method of claim 8, wherein the plan includes one or both of resources or crew rosters for the trip.

11. The method of claim 10, further comprising scheduling, by the one or more control units, resources after said determining and said discarding.

12. The method of claim 10, further comprising determining, by the one or more control units, one or more rosters of crew members for the trip after said determining and said discarding.

13. The method of claim 8, wherein the one or more vehicles includes one or more aircraft, and wherein the trip includes a plurality of flights between different airports.

14. The method of claim 8, wherein the rules comprise one or both of scheduling rules or rostering rules.

15. A non-transitory computer-readable storage medium comprising executable instructions that, in response to execution, cause one or more control units comprising a processor, to perform operations comprising:
receiving a compiled ruleset including rules;
receiving a plan for a trip for one or more vehicles;
determining if the rules are applicable to the plan; and
discarding each of the plurality of rules that is not applicable to the plan.

16. The non-transitory computer-readable storage medium of claim 15, wherein said determining and said discarding occur during runtime.

17. The non-transitory computer-readable storage medium of claim 15, wherein the plan includes one or both of resources or crew rosters for the trip.

18. The non-transitory computer-readable storage medium of claim 17, further comprising scheduling resources after said determining and said discarding.

19. The non-transitory computer-readable storage medium of claim 17, further comprising determining one or more rosters of crew members for the trip after said determining and said discarding.

20. The non-transitory computer-readable storage medium of claim 15, wherein the one or more vehicles includes one or more aircraft, wherein the trip includes a plurality of flights between different airports, and wherein the rules include one or both of scheduling rules or rostering rules.
